(19) United States
(12) Patent Application Publication
(10) Pub. No.: US 2026/0116057 A1
(43) Pub. Date: Apr. 30, 2026

(54) RECYCLABLE MULTILAYER FILMS HAVING A SEALING LAYER FORMED FROM A BLEND OF POLYPROPYLENES

(71) Applicant: BOREALIS AG, Vienna (AT)

(72) Inventors: Jingbo Wang, Linz (AT); Markus Gahleitner, Linz (AT); Klaus Bernreitner, Linz (AT); Peter Niedersüss, Linz (AT); Stefan Ortner, Linz (AT)

(21) Appl. No.: 19/161,881

(22) PCT Filed: Mar. 8, 2024
(86) PCT No.: PCT/EP2024/056146

§ 371 Date: Sep. 3, 2025

(30) Foreign Application Priority Data
Mar. 8, 2023 (EP) 23160784.7

(51) Int. Cl. B32B 27/32; B32B 27/08; C08L 23/14

(52) U.S. Cl. CPC B32B 27/32; B32B 27/08; C08L 23/14; B32B 2250/03; B32B 2250/242; B32B 2307/31; B32B 2439/00

(57) ABSTRACT

A multilayer film (F), comprising, in the given order, the following layers: (A) a skin layer; (B) a core layer; and (C) a sealing layer, comprising at least 90 wt.-% of a polypropylene composition (PC) comprising the following components: i) 20 to 70 wt.-% of a RAHECO having an MFR₂ of 0.1 to 10.0 g/10 min; ii) 10 to 50 wt.-% of a first propylene-ethylene random copolymer (R-PP1) having an MFR₂of 1.0 to 6.0 g/10 min; and iii) 10 to 50 wt.-% of a second propylene-ethylene random copolymer (R-PP2) having an MFR₂ of 7.0 to 20 g/10 min.

### FIELD OF THE INVENTION

The present invention relates to a multilayer film (F) comprising a skin layer, a core layer and a sealing layer, wherein the sealing layer comprises a polypropylene composition comprising a RAHECO and two propylene-ethylene random copolymers.

### BACKGROUND TO THE INVENTION

Plastic packaging is widely used in daily life due to a favorable cost/performance ratio. Polyolefins are easy and economical to produce with good properties and are widely used in plastic packaging.

Conflicting properties are often required in the packing industry. For example, high stiffness and toughness as well as excellent sealing behavior and good optical properties are required in parallel for plastic films. Different types of polyolefin, for example polypropylene and polyethylene, are routinely combined in blends and/or used in different layers of multilayer films to achieve desired properties. However, use of more than one polymer type complicates the task of recycling the resulting plastic packaging.

One approach to enabling recycling is a ‘single material solution’, where only one type of polymer material is used. This simplifies recycling of both post-consumer waste and manufacturing waste but limits the range of properties that are available. As such, there is still a need for plastic packaging that may be formed from a single polymer type though comprising various different polymer grades within that polymer type, optimizing the mechanical, optical and sealing properties required for packaging materials, whilst also being straightforward to recycle.

### SUMMARY OF THE INVENTION

Therefore, the present invention is directed to a multilayer film (F), comprising, in the given order, the following layers:
(A) a skin layer, comprising at least 90 wt.-%, based on the total weight of the skin layer, of a polypropylene or mixture of polypropylenes;
(B) a core layer, comprising at least 90 wt.-%, based on the total weight of the core layer, of a polypropylene or mixture of polypropylenes;
(C) a sealing layer, comprising at least 90 wt.-%, based on the total weight of the sealing layer, of a polypropylene composition (PC) comprising the following components:
   i) 20 to 70 wt.-%, based on the total weight of the polypropylene composition (PC), of a random-heterophasic propylene-ethylene copolymer (RAHECO), having a melt flow rate (MFR₂), determined according to ISO 1133 at 230° C. and 2.16 kg, in the range from 0.1 to 10.0 g/10 min, comprising:
      a) a crystalline matrix (M) being a propylene-ethylene random copolymer; and
      b) an amorphous propylene-ethylene elastomer (E);
   ii) 10 to 50 wt.-%, based on the total weight of the polypropylene composition (PC), of a first propylene-ethylene random copolymer (R-PP1) having a melt flow rate (MFR₂), determined according to ISO 1133 at 230° C. and 2.16 kg, in the range from 1.0 to 6.0 g/10 min; and
   iii) 10 to 50 wt.-%, based on the total weight of the polypropylene composition (PC), of a second propylene-ethylene random copolymer (R-PP2) having a melt flow rate (MFR₂), determined according to ISO 1133 at 230° C. and 2.16 kg, in the range from 7.0 to 20 g/10 min
   wherein the combined amounts of the random-heterophasic propylene-ethylene copolymer (RAHECO), the first propylene-ethylene random copolymer (R-PP1) and the second propylene-ethylene random copolymer (R-PP2) are at least 90 wt.-%, more preferably at least 95 wt.-%, most preferably at least 97 wt.-%, relative to the total weight of the polypropylene composition (PC).

### Definitions

Unless defined otherwise, all technical and scientific terms used herein have the same meaning as commonly understood by one of ordinary skill in the art to which the invention pertains. Although, any methods and materials similar or equivalent to those described herein can be used in practice for testing of the present invention, the preferred materials and methods are described herein. In describing and claiming the present invention, the following terminology will be used in accordance with the definitions set out below.

Unless clearly indicated otherwise, use of the terms “a,” “an,” and the like refers to one or more.

In the following, amounts are given in % by weight (wt.-%) unless it is stated otherwise.

A propylene homopolymer is a polymer that essentially consists of propylene monomer units. Due to impurities especially during commercial polymerization processes, a propylene homopolymer can comprise up to 0.1 mol-% comonomer units, preferably up to 0.05 mol-% comonomer units and most preferably up to 0.01 mol-% comonomer units.

A propylene copolymer is a copolymer of propylene monomer units and comonomer units, preferably selected from ethylene and C₄-C₈ alpha-olefins. A propylene random copolymer is a propylene copolymer wherein the comonomer units are randomly distributed along the polymer chain, whilst a propylene block copolymer comprises blocks of propylene monomer units and blocks of comonomer units. Propylene random copolymers can comprise comonomer units from one or more comonomers different in their amounts of carbon atoms.

Heterophasic propylene copolymers typically comprise:
a) a crystalline propylene homopolymer or copolymer matrix (M); and
b) an elastomeric rubber, preferably a propylene-ethylene elastomer (E);

In case of a random-heterophasic propylene copolymer, said crystalline matrix phase is a random copolymer of propylene and at least one alpha-olefin comonomer.

The elastomeric phase can be a propylene copolymer with a high amount of comonomer that is not randomly distributed in the polymer chain but is distributed in a comonomer-rich block structure and a propylene-rich block structure. A heterophasic polypropylene usually differentiates from a one-phasic propylene copolymer in that it shows two distinct glass transition temperatures Tg which are attributed to the matrix phase and the elastomeric phase.

The present invention will now be described in more detail.

### DETAILED DESCRIPTION

Therefore, the present invention is directed to a multilayer film (F), comprising, in the given order, the following layers:
(A) a skin layer;
(B) a core layer; and
(C) a sealing layer.

### Sealing Layer

The sealing layer of the present invention comprises at least 90 wt.-% of a polypropylene composition (PC), more preferably at least 95 wt.-% of the polypropylene composition (PC), yet more preferably at least 97 wt.-% of the polypropylene composition (PC), most preferably the polypropylene composition (PC) consists of the polypropylene composition (PC).

The polypropylene composition (PC) comprises the following components:
i) 20 to 70 wt.-%, based on the total weight of the polypropylene composition (PC), of a random-heterophasic propylene-ethylene copolymer (RAHECO);
ii) 10 to 50 wt.-%, based on the total weight of the polypropylene composition (PC), of a first propylene-ethylene random copolymer (R-PP1); and
iii) 10 to 50 wt.-%, based on the total weight of the polypropylene composition (PC), of a second propylene-ethylene random copolymer (R-PP2).

The combined amounts of the random-heterophasic propylene-ethylene copolymer (RAHECO), the first propylene-ethylene random copolymer (R-PP1) and the second propylene-ethylene random copolymer (R-PP2) are at least 90 wt.-%, more preferably at least 95 wt.-%, even more preferably at least 97 wt.-%, relative to the total weight of the polypropylene composition (PC).

More preferably, the polypropylene composition (PC) comprises the following components:
i) 25 to 60 wt.-%, based on the total weight of the polypropylene composition (PC), of a random-heterophasic propylene-ethylene copolymer (RAHECO);
ii) 12 to 48 wt.-%, based on the total weight of the polypropylene composition (PC), of a first propylene-ethylene random copolymer (R-PP1); and
iii) 12 to 48 wt.-%, based on the total weight of the polypropylene composition (PC), of a second propylene-ethylene random copolymer (R-PP2).

Most preferably, the polypropylene composition (PC) comprises the following components:
i) 30 to 50 wt.-%, based on the total weight of the polypropylene composition (PC), of a random-heterophasic propylene-ethylene copolymer (RAHECO);
ii) 15 to 45 wt.-%, based on the total weight of the polypropylene composition (PC), of a first propylene-ethylene random copolymer (R-PP1); and
iii) 15 to 45 wt.-%, based on the total weight of the polypropylene composition (PC), of a second propylene-ethylene random copolymer (R-PP2).

In one particularly preferred embodiment, the polypropylene composition (PC) comprises the following components:
i) 30 to 50 wt.-%, based on the total weight of the polypropylene composition (PC), of a random-heterophasic propylene-ethylene copolymer (RAHECO);
ii) 10 to 20 wt.-%, based on the total weight of the polypropylene composition (PC), of a first propylene-ethylene random copolymer (R-PP1); and
iii) 40 to 50 wt.-%, based on the total weight of the polypropylene composition (PC), of a second propylene-ethylene random copolymer (R-PP2).

In an alternative embodiment, the polypropylene composition (PC) comprises the following components:
i) 30 to 50 wt.-%, based on the total weight of the polypropylene composition (PC), of a random-heterophasic propylene-ethylene copolymer (RAHECO);
ii) 25 to 35 wt.-%, based on the total weight of the polypropylene composition (PC), of a first propylene-ethylene random copolymer (R-PP1); and
iii) 25 to 35 wt.-%, based on the total weight of the polypropylene composition (PC), of a second propylene-ethylene random copolymer (R-PP2).

In another alternative embodiment, the polypropylene composition (PC) comprises the following components:
i) 30 to 50 wt.-%, based on the total weight of the polypropylene composition (PC), of a random-heterophasic propylene-ethylene copolymer (RAHECO);
ii) 40 to 50 wt.-%, based on the total weight of the polypropylene composition (PC), of a first propylene-ethylene random copolymer (R-PP1); and
iii) 10 to 20 wt.-%, based on the total weight of the polypropylene composition (PC), of a second propylene-ethylene random copolymer (R-PP2).

If components other than the random-heterophasic propylene-ethylene copolymer (RAHECO), the first propylene-ethylene random copolymer (R-PP1), and the second propylene-ethylene random copolymer (R-PP2) are present, it is preferred that these are additives.

The skilled practitioner would be able to select suitable additives that are well known in the art.

The additives are preferably selected from pigments, antioxidants, UV-stabilisers, anti-scratch agents, mold release agents, acid scavengers, lubricants, anti-static agents, and mixtures thereof.

It is understood that the content of additives includes any carrier polymers used to introduce the additives to the polypropylene composition (PC), i.e. masterbatch carrier polymers. An example of such a carrier polymer would be a polypropylene homopolymer in the form of powder.

The individual components will now be described in more detail.

### Random-Heterophasic Propylene-Ethylene Copolymer (RAHECO)

The random-heterophasic propylene-ethylene copolymer (RAHECO) is provided in an amount in the range from 20.0 to 70.0 wt.-%, more preferably in the range from 25.0 to 60.0 wt.-%, most preferably in the range from 30.0 to 50.0 wt.-%, relative to the total weight of the polypropylene composition (PC).

The random-heterophasic propylene-ethylene copolymer (RAHECO) comprises:
a) a crystalline matrix (M) being a propylene-ethylene random copolymer; and
b) an amorphous propylene-ethylene elastomer (E).

The random-heterophasic propylene-ethylene copolymer (RAHECO) has a melt flow rate (MFR₂), determined according to ISO 1133 at 230° C. and 2.16 kg, in the range from 0.1 to 10.0 g/10 min, more preferably in the range from 0.3 to 5.0 g/10 min, most preferably in the range from 0.5 to 2.0 g/10 min.

The random-heterophasic propylene-ethylene copolymer (RAHECO) preferably has a melting temperature (Tm), determined by differential scanning calorimetry (DSC), in the range from 130 to 155° C., more preferably in the range from 134 to 150° C., most preferably in the range from 138 to 145° C.

The crystalline matrix (M) of the random-heterophasic propylene-ethylene copolymer (RAHECO) is preferably free of 2,1-regiodefects, as determined by ¹³C-NMR spectroscopy.

Being free of 2,1-regiodefects is an indication that the random-heterophasic propylene-ethylene copolymer (RAHECO) has been polymerized in the presence of a Ziegler-Natta catalyst.

Therefore, it is further preferred that the random-heterophasic propylene-ethylene copolymer (RAHECO) has been polymerized in the presence of a Ziegler-Natta catalyst.

The polymeric part of the random-heterophasic propylene-ethylene copolymer (RAHECO) may be characterized according to the CRYSTEX QC method using trichlorobenzene (TCB) as a solvent. This method is described below in the determination methods section. The crystalline fraction (CF) contains for the most part the matrix phase and only a small part of the elastomeric phase and the soluble fraction (SF) contains for the most part the elastomeric phase and only a small part of the matrix phase. In some cases, this method results in more useful data, since the crystalline fraction (CF) and the soluble fraction (SF) more accurately correspond to the matrix and elastomeric phases respectively. Due to the differences in the separation methods of xylene extraction and CRYSTEX QC method the properties of XCS/XCI fractions on the one hand and crystalline/soluble (CF/SF) fractions on the other hand are not exactly the same, meaning that the amounts of matrix phase and elastomeric phase can differ as well as the properties.

The random-heterophasic propylene-ethylene copolymer (RAHECO) preferably has an ethylene content (C2(total)), determined by CRYSTEX QC analysis, in the range from 3.0 to 15.0 wt.-%, more preferably in the range from 5.0 to 13.0 wt.-%, most preferably in the range from 7.0 to 11.0 wt.-%.

The random-heterophasic propylene-ethylene copolymer (RAHECO) preferably has a soluble fraction (SF) content, determined by CRYSTEX QC analysis, in the range from 10 to 45 wt.-%, more preferably in the range from 13 to 35 wt.-%, most preferably in the range from 16 to 25 wt.-%.

The random-heterophasic propylene-ethylene copolymer (RAHECO) preferably has an ethylene content of the soluble fraction (C2(SF)), determined by CRYSTEX QC analysis, in the range from 17.0 to 60.0 wt.-%, more preferably in the range from 20.0 to 50.0 wt.-%, most preferably in the range from 25.0 to 40.0 wt.-%.

The random-heterophasic propylene-ethylene copolymer (RAHECO) preferably has an intrinsic viscosity of the soluble fraction (iV(SF)), determined by CRYSTEX QC analysis, in the range from 1.20 to 4.50 dL/g, more preferably in the range from 2.00 to 4.00 dL/g, most preferably in the range from 2.40 to 3.40 dL/g.

The random-heterophasic propylene-ethylene copolymer (RAHECO) preferably has a crystalline fraction (CF) content, determined by CRYSTEX QC analysis, in the range from 55 to 90 wt.-%, more preferably in the range from 65 to 87 wt.-%, most preferably in the range from 75 to 84 wt.-%.

The random-heterophasic propylene-ethylene copolymer (RAHECO) preferably has an ethylene content of the crystalline fraction (C2(CF)), determined by CRYSTEX QC analysis, in the range from 1.0 to 8.0 wt.-%, more preferably in the range from 2.0 to 7.0 wt.-%, most preferably in the range from 3.0 to 6.0 wt.-%.

The random-heterophasic propylene-ethylene copolymer (RAHECO) preferably has an intrinsic viscosity of the crystalline fraction (iV(CF)), determined by CRYSTEX QC analysis, in the range from 1.20 to 4.50 dL/g, more preferably in the range from 2.00 to 4.00 dL/g, most preferably in the range from 2.60 to 3.60 dL/g.

It is also preferred that the ratio of the intrinsic viscosity of the soluble and crystalline fractions, (iV(SF)/iV(CF)), determined by CRYSTEX QC analysis, is in the range from 0.50 to 2.00, more preferably in the range from 0.75 to 1.50, most preferably in the range from 0.90 to 1.10.

### First Propylene-Ethylene Random Copolymer (R-PP1)

The first propylene-ethylene random copolymer (R-PP1) is present in the polypropylene composition (PC) in an amount in the range from 10.0 to 50.0 wt.-%, more preferably from 12.0 to 48.0 wt.-%, most preferably from 15.0 to 45.0 wt.-%, relative to the total weight of the polypropylene composition (PC).

As would be understood by the person skilled in the art, in contrast to the random-heterophasic propylene-ethylene copolymer (RAHECO), the first propylene-ethylene random copolymer (R-PP1) is monophasic.

The first propylene-ethylene random copolymer (R-PP1) is a random copolymer with propylene monomer units and ethylene comonomer units.

The first propylene-ethylene random copolymer (R-PP1) has a melt flow rate (MFR₂), determined according to ISO 1133 at 230° C. and 2.16 kg, in the range from 1.0 to 6.0 g/10 min, more preferably in the range from 1.2 to 4.5 g/10 min, most preferably in the range from 1.6 to 3.0 g/10 min.

The first propylene-ethylene random copolymer (R-PP1) preferably has an ethylene content (C2), determined by quantitative ¹³C-NMR spectroscopy, in the range from 1.0 to 5.5 wt.-%, more preferably in the range from 1.0 to 3.5 wt.-%, most preferably in the range from 1.0 to 2.0 wt.-%.

The first propylene-ethylene random copolymer (R-PP1) preferably has a xylene cold soluble (XCS) content, determined according to ISO 16152 analysis, in the range from 0.2 to 5.0 wt.-%, more preferably in the range from 0.3 to 3.0 wt.-%, most preferably in the range from 0.4 to 1.0 wt.-%.

The first propylene-ethylene random copolymer (R-PP1) preferably has a melting temperature (Tm), determined by differential scanning calorimetry (DSC), in the range from 130 to 155° C., more preferably in the range from 136 to 151° C., most preferably in the range from 142 to 148° C.

The first propylene-ethylene random copolymer (R-PP1) preferably has a crystallization temperature (Tc), determined by differential scanning calorimetry (DSC), in the range from 110 to 125° C., more preferably in the range from 112 to 122° C., most preferably in the range from 114 to 119° C.

The first propylene-ethylene random copolymer (R-PP1) preferably has a content of 2,1-regiodefects, as determined by ¹³C-NMR spectroscopy, in the range from 0.05 to 1.40 mol-%, more preferably in the range from 0.10 to 1.10 mol-%, most preferably in the range from 0.20 to 0.90 mol-%.

The presence of 2,1-regiodefects is an indication that the first propylene-ethylene random copolymer (R-PP1) has been polymerized in the presence of a single site catalyst (SSC).

Therefore, it is further preferred that the first propylene-ethylene random copolymer (R-PP1) has been polymerized in the presence of a single site catalyst (SSC).

### Second Propylene-Ethylene Random Copolymer (R-PP2)

The second propylene-ethylene random copolymer (R-PP2) is present in the polypropylene composition (PC) in an amount in the range from 10.0 to 50.0 wt.-%, more preferably from 12.0 to 48.0 wt.-%, most preferably from 15.0 to 45.0 wt.-%, relative to the total weight of the polypropylene composition (PC).

As would be understood by the person skilled in the art, in contrast to the random-heterophasic propylene-ethylene copolymer (RAHECO), the second propylene-ethylene random copolymer (R-PP2) is monophasic.

The second propylene-ethylene random copolymer (R-PP2) is a random copolymer with propylene monomer units and ethylene comonomer units.

The second propylene-ethylene random copolymer (R-PP2) has a melt flow rate (MFR₂), determined according to ISO 1133 at 230° C. and 2.16 kg, in the range from 7.0 to 20.0 g/10 min, more preferably in the range from 8.0 to 17.0 g/10 min, most preferably in the range from 9.0 to 14.0 g/10 min.

The second propylene-ethylene random copolymer (R-PP2) preferably has an ethylene content (C2), determined by quantitative ¹³C-NMR spectroscopy, in the range from 1.0 to 5.5 wt.-%, more preferably in the range from 1.5 to 4.0 wt.-%, most preferably in the range from 2.0 to 3.0 wt.-%.

The second propylene-ethylene random copolymer (R-PP2) preferably has a xylene cold soluble (XCS) content, determined according to ISO 16152 analysis, in the range from 0.2 to 5.0 wt.-%, more preferably in the range from 0.3 to 3.0 wt.-%, most preferably in the range from 0.4 to 1.0 wt.-%.

The second propylene-ethylene random copolymer (R-PP2) preferably has a melting temperature (Tm), determined by differential scanning calorimetry (DSC), in the range from 125 to 145° C., more preferably in the range from 126 to 135° C., most preferably in the range from 127 to 130° C.

The second propylene-ethylene random copolymer (R-PP2) preferably has a crystallization temperature (Tc), determined by differential scanning calorimetry (DSC), in the range from 100 to 120° C., more preferably in the range from 103 to 115° C., most preferably in the range from 106 to 110° C.

The second propylene-ethylene random copolymer (R-PP2) preferably has a content of 2,1-regiodefects, as determined by ¹³C-NMR spectroscopy, in the range from 0.05 to 1.40 mol-%, more preferably in the range from 0.10 to 1.10 mol-%, most preferably in the range from 0.20 to 0.90 mol-%.

The presence of 2,1-regiodefects is an indication that the second propylene-ethylene random copolymer (R-PP2) has been polymerized in the presence of a single site catalyst (SSC).

Therefore, it is further preferred that the second propylene-ethylene random copolymer (R-PP2) has been polymerized in the presence of a single site catalyst (SSC).

### Skin Layer and Core Layer

The skin layer (A) and the core layer (B) each comprise at least 90 wt.-%, more preferably at least 95 wt.-%, most preferably at least 97 wt.-%, of a polypropylene or mixture of polypropylenes.

The compositions of skin layer (A) and of core layer (B) may be the same or different. Preferably, the composition of skin layer (A) is the same as the composition of core layer (B).

In the broadest sense, any polypropylene may be used for the skin layer (A) and core layer (B).

It is however, preferred that the skin layer (A) comprises at least 90 wt.-%, more preferably at least 95 wt.-%, most preferably at least 97 wt.-%, of a heterophasic propylene-ethylene copolymer or a mixture of heterophasic propylene-ethylene copolymers.

Likewise, it is preferred that the core layer (B) comprises at least 90 wt.-%, more preferably at least 95 wt.-%, most preferably at least 97 wt.-%, of a heterophasic propylene-ethylene copolymer or a mixture of heterophasic propylene-ethylene copolymers.

It is particularly preferred that the skin layer (A) comprises at least 90 wt.-%, more preferably at least 95 wt.-%, most preferably at least 97 wt.-%, of a polypropylene composition (PC′) that comprises:
i) from 15 to 45 wt.-%, based on the total weight of the polypropylene
   composition (PC′), of a random-heterophasic propylene-ethylene copolymer (RAHECO′),
   wherein the random-heterophasic propylene-ethylene copolymer (RAHECO′) comprises:
      a1) a crystalline matrix (M) being a propylene-ethylene random copolymer; and
      b1) an amorphous propylene-ethylene elastomer (E), and
ii) from 55 to 85 wt.-%, based on the total weight of the polypropylene composition (PC′), of a heterophasic propylene-ethylene copolymer (HECO),
   wherein the heterophasic propylene-ethylene copolymer (HECO) comprises:
      a2) a crystalline matrix (M) being a propylene homopolymer; and
      b2) an amorphous propylene-ethylene elastomer (E).

The combined amounts of the random-heterophasic propylene-ethylene copolymer (RAHECO′) and the heterophasic propylene-ethylene copolymer (HECO) are at least 90 wt.-%, more preferably at least 95 wt.-%, most preferably at least 97 wt.-%, relative to the total weight of the polypropylene composition (PC′).

More preferably, the polypropylene composition (PC′) comprises:
i) from 20 to 40 wt.-%, based on the total weight of the polypropylene composition (PC′), of the random-heterophasic propylene-ethylene copolymer (RAHECO′), and
ii) from 60 to 80 wt.-%, based on the total weight of the polypropylene composition (PC′), of the heterophasic propylene-ethylene copolymer (HECO).

More preferably, the polypropylene composition (PC′) comprises:
i) from 25 to 35 wt.-%, based on the total weight of the polypropylene composition (PC′), of the random-heterophasic propylene-ethylene copolymer (RAHECO′), and
ii) from 65 to 75 wt.-%, based on the total weight of the polypropylene composition (PC′), of the heterophasic propylene-ethylene copolymer (HECO).

It is likewise particularly preferred that the core layer (B) comprises at least 90 wt.-%, more preferably at least 95 wt.-%, most preferably at least 97 wt.-%, of a polypropylene composition (PC′) that comprises:
i) from 15 to 45 wt.-%, based on the total weight of the polypropylene
   composition (PC′), of a random-heterophasic propylene-ethylene copolymer (RAHECO′),
   wherein the random-heterophasic propylene-ethylene copolymer (RAHECO′) comprises:
      a1) a crystalline matrix (M) being a propylene-ethylene random copolymer; and
      b1) an amorphous propylene-ethylene elastomer (E), and
ii) from 55 to 85 wt.-%, based on the total weight of the polypropylene composition (PC′), of a heterophasic propylene-ethylene copolymer (HECO),
   wherein the heterophasic propylene-ethylene copolymer (HECO) comprises:
      a2) a crystalline matrix (M) being a propylene homopolymer; and
      b2) an amorphous propylene-ethylene elastomer (E).

The combined amounts of the random-heterophasic propylene-ethylene copolymer (RAHECO′) and the heterophasic propylene-ethylene copolymer (HECO) are at least 90 wt.-%, more preferably at least 95 wt.-%, most preferably at least 97 wt.-%, relative to the total weight of the polypropylene composition (PC′).

More preferably, the polypropylene composition (PC′) of the core layer (B) comprises:
i) from 20 to 40 wt.-%, based on the total weight of the polypropylene composition (PC′), of the random-heterophasic propylene-ethylene copolymer (RAHECO′), and
ii) from 60 to 80 wt.-%, based on the total weight of the polypropylene composition (PC′), of the heterophasic propylene-ethylene copolymer (HECO).

More preferably, the polypropylene composition (PC′) of the core layer (B) comprises:
i) from 25 to 35 wt.-%, based on the total weight of the polypropylene composition (PC′), of the random-heterophasic propylene-ethylene copolymer (RAHECO′), and
ii) from 65 to 75 wt.-%, based on the total weight of the polypropylene composition (PC′), of the heterophasic propylene-ethylene copolymer (HECO).

If components other than the random-heterophasic propylene-ethylene copolymer (RAHECO′), and the heterophasic propylene-ethylene copolymer (HECO) are present, it is preferred that these are additives.

The skilled practitioner would be able to select suitable additives that are well known in the art.

The additives are preferably selected from pigments, antioxidants, UV-stabilisers, anti-scratch agents, mold release agents, acid scavengers, lubricants, anti-static agents, and mixtures thereof.

It is understood that the content of additives includes any carrier polymers used to introduce the additives to the polypropylene composition (PC′), i.e. masterbatch carrier polymers. An example of such a carrier polymer would be a polypropylene homopolymer in the form of powder.

The individual components will now be described in more detail.

### Random-Heterophasic Propylene-Ethylene Copolymer (RAHECO′)

The random-heterophasic propylene-ethylene copolymer (RAHECO′) is provided in an amount in the range from 15.0 to 45.0 wt.-%, more preferably in the range from 20.0 to 40.0 wt.-%, most preferably in the range from 25.0 to 35.0 wt.-%, relative to the total weight of the polypropylene composition (PC′).

The random-heterophasic propylene-ethylene copolymer (RAHECO′) comprises:
a1) a crystalline matrix (M) being a propylene-ethylene random copolymer; and
b1) an amorphous propylene-ethylene elastomer (E).

The random-heterophasic propylene-ethylene copolymer (RAHECO′) preferably has a melt flow rate (MFR₂), determined according to ISO 1133 at 230° C. and 2.16 kg, in the range from 0.1 to 10.0 g/10 min, more preferably in the range from 0.3 to 5.0 g/10 min, most preferably in the range from 0.5 to 2.0 g/10 min.

The random-heterophasic propylene-ethylene copolymer (RAHECO′) has a melting temperature (Tm), determined by differential scanning calorimetry (DSC), in the range from 130 to 155° C., more preferably in the range from 134 to 150° C., most preferably in the range from 138 to 145° C.

The crystalline matrix (M) of the random-heterophasic propylene-ethylene copolymer (RAHECO′) is preferably free of 2,1-regiodefects, as determined by ¹³C-NMR spectroscopy.

Being free of 2,1-regiodefects is an indication that the random-heterophasic propylene-ethylene copolymer (RAHECO′) has been polymerized in the presence of a Ziegler-Natta catalyst.

Therefore, it is further preferred that the random-heterophasic propylene-ethylene copolymer (RAHECO′) has been polymerized in the presence of a Ziegler-Natta catalyst.

The random-heterophasic propylene-ethylene copolymer (RAHECO′) preferably has an ethylene content (C2(total)), determined by CRYSTEX QC analysis, in the range from 3.0 to 15.0 wt.-%, more preferably in the range from 5.0 to 13.0 wt.-%, most preferably in the range from 7.0 to 11.0 wt.-%.

The random-heterophasic propylene-ethylene copolymer (RAHECO′) preferably has a soluble fraction (SF) content, determined by CRYSTEX QC analysis, in the range from 10 to 45 wt.-%, more preferably in the range from 13 to 35 wt.-%, most preferably in the range from 16 to 25 wt.-%.

The random-heterophasic propylene-ethylene copolymer (RAHECO′) preferably has an ethylene content of the soluble fraction (C2(SF)), determined by CRYSTEX QC analysis, in the range from 17.0 to 60.0 wt.-%, more preferably in the range from 20.0 to 50.0 wt.-%, most preferably in the range from 25.0 to 40.0 wt.-%.

The random-heterophasic propylene-ethylene copolymer (RAHECO′) preferably has an intrinsic viscosity of the soluble fraction (iV(SF)), determined by CRYSTEX QC analysis, in the range from 1.20 to 4.50 dL/g, more preferably in the range from 2.00 to 4.00 dL/g, most preferably in the range from 2.40 to 3.40 dL/g.

The random-heterophasic propylene-ethylene copolymer (RAHECO′) preferably has a crystalline fraction (CF) content, determined by CRYSTEX QC analysis, in the range from 55 to 90 wt.-%, more preferably in the range from 65 to 87 wt.-%, most preferably in the range from 75 to 84 wt.-%.

The random-heterophasic propylene-ethylene copolymer (RAHECO′) preferably has an ethylene content of the crystalline fraction (C2(CF)), determined by CRYSTEX QC analysis, in the range from 1.0 to 8.0 wt.-%, more preferably in the range from 2.0 to 7.0 wt.-%, most preferably in the range from 3.0 to 6.0 wt.-%.

The random-heterophasic propylene-ethylene copolymer (RAHECO′) preferably has an intrinsic viscosity of the crystalline fraction (iV(CF)), determined by CRYSTEX QC analysis, in the range from 1.20 to 4.50 dL/g, more preferably in the range from 2.00 to 4.00 dL/g, most preferably in the range from 2.60 to 3.60 dL/g.

It is also preferred that the ratio of the intrinsic viscosity of the soluble and crystalline fractions, (iV(SF)/iV(CF)), determined by CRYSTEX QC analysis, is in the range from 0.50 to 2.00, more preferably in the range from 0.75 to 1.50, most preferably in the range from 0.90 to 1.10.

It is particularly preferred that the random-heterophasic propylene-ethylene copolymer (RAHECO′) of the polypropylene composition (PC′) of the skin and/or core layer is the same as the random-heterophasic propylene-ethylene copolymer (RAHECO) of the polypropylene composition (PC) of the sealing layer.

### Heterophasic Propylene-Ethylene Copolymer (HECO)

The heterophasic propylene-ethylene copolymer (HECO) is provided in an amount in the range from 55.0 to 85.0 wt.-%, more preferably in the range from 60.0 to 80.0 wt.-%, most preferably in the range from 65.0 to 75.0 wt.-%, relative to the total weight of the polypropylene composition (PC′).

The heterophasic propylene-ethylene copolymer (HECO) comprises:
a2) a crystalline matrix (M) being a propylene homopolymer; and
b2) an amorphous propylene-ethylene elastomer (E).

The heterophasic propylene-ethylene copolymer (HECO) preferably has a melt flow rate (MFR₂), determined according to ISO 1133 at 230° C. and 2.16 kg, in the range from 0.1 to 6.0 g/10 min, more preferably in the range from 0.3 to 3.0 g/10 min, most preferably in the range from 0.5 to 1.0 g/10 min.

The heterophasic propylene-ethylene copolymer (HECO) has a melting temperature (Tm), determined by differential scanning calorimetry (DSC), in the range from 150 to 170° C., more preferably in the range from 155 to 168° C., most preferably in the range from 160 to 167° C.

The crystalline matrix (M) of the heterophasic propylene-ethylene copolymer (HECO) is preferably free of 2,1-regiodefects, as determined by ¹³C-NMR spectroscopy.

Being free of 2,1-regiodefects is an indication that the heterophasic propylene-ethylene copolymer (HECO) has been polymerized in the presence of a Ziegler-Natta catalyst.

Therefore, it is further preferred that the heterophasic propylene-ethylene copolymer (HECO) has been polymerized in the presence of a Ziegler-Natta catalyst.

The heterophasic propylene-ethylene copolymer (HECO) preferably has an ethylene content (C2(total)), determined by CRYSTEX QC analysis, in the range from 3.0 to 15.0 wt.-%, more preferably in the range from 4.0 to 12.0 wt.-%, most preferably in the range from 5.0 to 9.0 wt.-%.

The heterophasic propylene-ethylene copolymer (HECO) preferably has a soluble fraction (SF) content, determined by CRYSTEX QC analysis, in the range from 5 to 30 wt.-%, more preferably in the range from 10 to 25 wt.-%, most preferably in the range from 12 to 20 wt.-%.

The heterophasic propylene-ethylene copolymer (HECO) preferably has an ethylene content of the soluble fraction (C2(SF)), determined by CRYSTEX QC analysis, in the range from 17.0 to 60.0 wt.-%, more preferably in the range from 20.0 to 50.0 wt.-%, most preferably in the range from 30.0 to 45.0 wt.-%.

The heterophasic propylene-ethylene copolymer (HECO) preferably has an intrinsic viscosity of the soluble fraction (iV(SF)), determined by CRYSTEX QC analysis, in the range from 1.20 to 4.50 dL/g, more preferably in the range from 1.70 to 4.00 dL/g, most preferably in the range from 2.20 to 3.30 dL/g.

The heterophasic propylene-ethylene copolymer (HECO) preferably has a crystalline fraction (CF) content, determined by CRYSTEX QC analysis, in the range from 70 to 95 wt.-%, more preferably in the range from 75 to 90 wt.-%, most preferably in the range from 80 to 88 wt.-%.

The first heterophasic propylene-ethylene copolymer (HECO) preferably has an ethylene content of the crystalline fraction (C2(CF)), determined by CRYSTEX QC analysis, in the range from 1.0 to 8.0 wt.-%, more preferably in the range from 2.0 to 6.0 wt.-%, most preferably in the range from 2.5 to 5.0 wt.-%.

The heterophasic propylene-ethylene copolymer (HECO) preferably has an intrinsic viscosity of the crystalline fraction (iV(CF)), determined by CRYSTEX QC analysis, in the range from 1.20 to 4.50 dL/g, more preferably in the range from 2.00 to 4.00 dL/g, most preferably in the range from 2.50 to 3.50 dL/g.

It is also preferred that the ratio of the intrinsic viscosity of the soluble and crystalline fractions, (iV(SF)/iV(CF)), determined by CRYSTEX QC analysis, is in the range from 0.50 to 2.00, more preferably in the range from 0.75 to 1.50, most preferably in the range from 0.90 to 1.10.

### Multilayer Film

As described above, the multilayer film (F) comprises, in the given order, the following layers:
(A) a skin layer;
(B) a core layer; and
(C) a sealing layer.

Although other layers may be present, it is preferred that any further layers, if present, are between the skin layer (A) and the core layer (B) or between the core layer (B) and between the sealing layer (C), most preferably between the skin layer (A) and the core layer (B).

It is particularly preferred that no further layers are present, i.e. that the multilayer film (F) is a 3-layer film, consisting of layers (A), (B) and (C).

It is preferred that the multilayer film (F) has a thickness in the range from 20 to 150 μm, more preferably 30 to 100 μm, most preferably 50 to 80 μm.

It is preferred that:
a) the skin layer has a thickness in the range from 10 to 40% of the total thickness of the multilayer film (F);
b) the core layer has a thickness in the range from 30 to 70% of the total thickness of the multilayer film (F); and
c) the sealing layer has a thickness in the range from 10 to 40% of the total thickness of the multilayer film (F).

It is further preferred that:
a) the skin layer has a thickness in the range from 15 to 35% of the total thickness of the multilayer film (F);
b) the core layer has a thickness in the range from 35 to 65% of the total thickness of the multilayer film (F); and
c) the sealing layer has a thickness in the range from 15 to 35% of the total thickness of the multilayer film (F).

It is particularly preferred that:
a) the skin layer has a thickness in the range from 20 to 30% of the total thickness of the multilayer film (F);
b) the core layer has a thickness in the range from 40 to 60% of the total thickness of the multilayer film (F); and
c) the sealing layer has a thickness in the range from 20 to 30% of the total thickness of the multilayer film (F).

It is preferred that the multilayer film (F) has a tensile modulus in the machine direction (TM-MD), measured according to ISO 527-3, in the range from 700 to 1500 MPa, more preferably in the range from 800 to 1300 MPa, most preferably in the range from 850 to 1100 MPa.

It is preferred that the multilayer film (F) has a tensile modulus in the transverse direction (TM-TD), measured according to ISO 527-3, in the range from 700 to 1500 MPa, more preferably in the range from 800 to 1300 MPa, most preferably in the range from 850 to 1100 MPa.

It is preferred that the multilayer film (F) has a dart drop impact strength (DDI), measured according to ISO 7765-1, in the range from 100 to 600 g, more preferably in the range from 200 to 500 g, most preferably in the range from 300 to 400 g.

It is preferred that the multilayer film (F) has a haze value, determined according to ASTM D1003, in the range from 10 to 40%, more preferably in the range from 15 to 35%, most preferably in the range from 20 to 30%.

It is preferred that the multilayer film (F) has a sealing initiation temperature (SIT), determined according to the method specified in the measurement methods, in the range from 115 to 130° C., more preferably in the range from 119 to 128° C., most preferably in the range from 122 to 127° C.

It is preferred that the multilayer film (F) has a seal strength before sterilization (b.s.), determined according to the method specified in the measurement methods, in the range from 15 to 40 N/mm, more preferably in the range from 18 to 35 N/mm, most preferably in the range from 20 to 30 N/mm.

It is preferred that the multilayer film (F) has a seal strength after sterilization (a.s.) determined according to the method specified in the measurement methods, in the range from 20 to 45 N/mm, more preferably in the range from 23 to 40 N/mm, most preferably in the range from 25 to 35 N/mm.

It is also preferred that the multilayer film (F) has a seal strength after sterilization (a.s.) that is at least 92%, more preferably at least 95%, most preferably at least 98%, of the seal strength before sterilization (b.s.), both determined according to the method specified in the measurement methods.

The seal strength after sterilization (a.s.) is typically not more than 125% of the seal strength before sterliziation.

### EXAMPLES

### 1. Measurement Methods

The following definitions of terms and determination methods apply for the above general description of the invention including the claims as well as to the below examples unless otherwise defined.

### Quantification of Microstructure by NMR Spectroscopy

Quantitative nuclear-magnetic resonance (NMR) spectroscopy was used to quantify the comonomer and regiodefect content of the polymers.

Quantitative ¹³C{¹H}NMR spectra were recorded in the solution-state using a Bruker Avance III 400 NMR spectrometer operating at 400.15 and 100.62 MHz for ¹H and ¹³C respectively. All spectra were recorded using a ¹³C optimised 10 mm extended temperature probehead at 125° C. using nitrogen gas for all pneumatics. Approximately 200 mg of material was dissolved in approximately 3 ml of 1,2-tetrachloroethane-d₂ (TCE-d₂) along with chromium-(III)-acetylacetonate (Cr(acac)₃) resulting in a 65 mM solution of relaxation agent in solvent {singh09}. To ensure a homogenous solution, after initial sample preparation in a heat block, the NMR tube was further heated in a rotatary oven for at least 1 hour. Upon insertion into the magnet the tube was spun at 10 Hz. This setup was chosen primarily for the high resolution and quantitatively needed for accurate ethylene content quantification. Standard single-pulse excitation was employed without NOE, using an optimised tip angle, 1 s recycle delay and a bi-level WALTZ16 decoupling scheme {zhou07,busico07}. A total of 6144 (6 k) transients were acquired per spectra.

Quantitative ¹³C{¹H}NMR spectra were processed, integrated and relevant quantitative properties determined from the integrals using proprietary computer programs. All chemical shifts were indirectly referenced to the central methylene group of the ethylene block (EEE) at 30.00 ppm using the chemical shift of the solvent. This approach allowed comparable referencing even when this structural unit was not present.

Characteristic signals corresponding to the incorporation of ethylene were observed {wang00, cheng84, randall89}.

The comonomer fraction was quantified using the method of Wang et. al. {wang00} through integration of multiple signals across the whole spectral region in the ¹³C{¹H} spectra. This method was chosen for its robust nature and ability to account for the presence of regiodefects when needed. Integral regions were slightly adjusted to increase applicability across the whole range of encountered comonomer contents.

For systems where only isolated ethylene in PPEPP sequences was observed the method of Wang et. al. was modified to reduce the influence of non-zero integrals of sites that are known to be not present. This approach reduced the overestimation of ethylene content for such systems and was achieved by reduction of the number of sites used to determine the absolute ethylene content. Through the use of this set of sites the corresponding integral equation becomes

$$\begin{matrix}{p}_{S} = {I}_{A} + ( 0.5 * {I}_{B} ) \\ {p}_{T} = {I}_{D} + {I}_{F} + {I}_{D} \\ p = ( {p}_{S} + {p}_{T} ) / 2 \\ e = 0.5 * ( {I}_{H} + ( 05 * {I}_{B} ) ) \\ fE = e / ( e + p )\end{matrix}$$

using the same notation used in the article of Wang et. al. {wang00}.

The mole percent comonomer incorporation was calculated from the mole fraction:

$$E [ mol \% ] = 100 * fE$$

The weight percent comonomer incorporation was calculated from the mole fraction:

$$E [ wt \% ] = 100 * ( fE * 28.06 ) / ( ( fE * 28.06 ) + ( ( 1 - fE ) * 42.08 ) )$$

Characteristic signals corresponding to regio defects were observed {resconi00, wang00}. The presence of isolated 2,1-erythro regio defects was indicated by the presence of the two methyl sites at 17.7 and 17.2 ppm and confirmed by other characteristic sites. The presence of 2,1 regio defect adjacent an ethylene unit was indicated by the two inequivalent Sαβ signals at 34.9 ppm and 34.7 ppm respectively and the Tγγ at 34.1 ppm.

The amount of isolated 2,1-erythro regio defects (P_{21e isolated}) was quantified using the average integral of the two characteristic methyl sites at 17.7 (Iₑ₈) and 17.4 (Iₑ₆) ppm respectively:

$${P}_{21 e isolated} = ( {I}_{e 6} + {I}_{e 8} ) / 2$$

The amount of 2,1 regio defect adjacent to ethylene (P_{E21}) was quantified using the methine site at 34.1 ppm (I_{Tγγ}):

$${P}_{E 21} = {I}_{T γ γ}$$

The total amount of propene (Pₜₒₜₐₗ) was quantified based on the methyl region (I_{CH3}) between 23.0 and 19.9 ppm with correction undertaken for sites included in this region not related to propene insertion. The methyl group P_{γγ} resulting from 2,1 regio defect adjacent to ethylene is already present in I_{CH3}:

$${P}_{t otal} = {I}_{C H 3} + 2 * {P}_{21 e isolated}$$

The isolated 2,1-erythro regio defects (P_{21e isolated}) is multiplied by 2 to take into account the two (2) propene units in the 2, 1-erythro regio defects.

The mole percent of isolated 2,1-erythro regio defects was quantified with respect to all propene:

$$[ 21 e ] mol \% = 100 * {P}_{21 e isolated} / {P}_{t otal}$$

The mole percent of 2,1 regio defects adjacent to ethylene was quantified with respect to all propene:

$$[ E 21 ] mol \% = 100 * {P}_{E 21} / {P}_{total}$$

The total amount of 2,1 defects was quantified as following:

$$[ 21 ] mol \% = [ 21 e ] + [ E 21 ]$$

Characteristic signals corresponding to other types of regio defects (2,1-threo, 3,1 insertion) were not observed {resconi00}.

| | |
|---|---|
| zhou07 | Zhou, Z., Kuemmerle, R., Qiu, X., Redwine, D., Cong, R., |
| | Taha, A., Baugh, D. Winniford, B., J. Mag. Reson. 187 |
| | (2007) 225 |
| busico07 | Busico, V., Carbonniere, P., Cipullo, R., Pellecchia, R., |
| | Severn, J., Talarico, G., Macromol. Rapid Commun. 2007, |
| | 28, 1128 |
| resconi00 | Resconi, L., Cavallo, L., Fait, A., Piemontesi, F., Chem. |
| | Rev. 2000, 100, 1253 |
| wang00 | Wang, W-J., Zhu, S., Macromolecules 33 (2000), 1157 |
| cheng84 | Cheng, H. N., Macromolecules 17 (1984), 1950 |
| singh09 | Singh, G., Kothari, A., Gupta, V., Polymer Testing 28 5 |
| | (2009), 475 |
| randall89 | Randall, J. Macromol. Sci., Rev. Macromol. Chem. Phys. |
| | 1989, C29, 201. |

### CRYSTEX QC Analysis

### Crystalline and Soluble Fractions Method

The crystalline (CF) and soluble fractions (SF) of the polypropylene (PP) compositions as well as the comonomer content and intrinsic viscosities of the respective fractions were analyzed by use of the CRYSTEX instrument, Polymer Char (Valencia, Spain). Details of the technique and the method can be found in literature (Ljiljana Jeremic, Andreas Albrecht, Martina Sandholzer & Markus Gahleitner (2020) Rapid characterization of high-impact ethylene-propylene copolymer composition by crystallization extraction separation: comparability to standard separation methods, International Journal of Polymer Analysis and Characterization, 25:8, 581-596)

The crystalline and amorphous fractions are separated through temperature cycles of dissolution at 160° C., crystallization at 40° C. and re-dissolution in 1,2,4-trichlorobenzene at 160° C. Quantification of SF and CF and determination of ethylene content (C2) are achieved by means of an integrated infrared detector (IR4) and for the determination of the intrinsic viscosity (IV) an online 2-capillary viscometer is used.

The IR4 detector is a multiple wavelength detector measuring IR absorbance at two different bands (CH₃ stretching vibration (centred at app. 2960 cm-1) and the CH stretching vibration (2700-3000 cm-1) that are serving for the determination of the concentration and the Ethylene content in Ethylene-Propylene copolymers. The IR4 detector is calibrated with series of 8 EP copolymers with known Ethylene content in the range of 2 wt.-% to 69 wt.-% (determined by ¹³C-NMR) and each at various concentrations, in the range of 2 and 13 mg/ml. To encounter for both features, concentration and ethylene content at the same time for various polymer concentrations expected during Crystex analyses the following calibration equations were applied:

$$Conc = a + b * Abs ( CH ) + c * {( Abs ( CH ) )}^{2} + d * Abs ( {CH}_{3} ) + e * ( Abs {( {CH}_{3} )}^{2} + f * Abs ( CH ) * Abs ( {CH}_{3} ) \qquad ( Equation 1 )$$

$${CH}_{3} / 1000 C = a + b * Abs ( CH ) + c * Abs ( {CH}_{3} ) + d * ( Abs ( {CH}_{3} ) / Abs ( C H ) ) + e * {( Abs ( {CH}_{3} ) / Abs ( CH ) )}^{2} \qquad ( Equation 2 )$$

The constants a to e for equation 1 and a to f for equation 2 were determined by using least square regression analysis.

The CH₃/1000C is converted to the ethylene content in wt.-% using following relationship:

$$Wt . - \% ( Ethylene in EP Copolymers ) = 100 - {CH}_{3} / 1000 TC * 0.3 \qquad ( Equation 3 )$$

Amounts of Soluble Fraction (SF) and Crystalline Fraction (CF) are correlated through the XS calibration to the “Xylene Cold Soluble” (XCS) quantity and respectively Xylene Cold Insoluble (XCI) fractions, determined according to standard gravimetric method as per ISO16152. XS calibration is achieved by testing various EP copolymers with XS content in the range 2-31 wt.-%. The determined XS calibration is linear:

$$Wt . - \% XS = 1 , 01 * Wt . - \% SF \qquad ( Equation 4 )$$

Intrinsic viscosity (IV) of the parent EP copolymer and its soluble and crystalline fractions are determined with a use of an online 2-capillary viscometer and are correlated to corresponding IV's determined by standard method in decalin according to ISO 1628-3. Calibration is achieved with various EP PP copolymers with IV=2-4 dL/g. The determined calibration curve is linear:

$$IV ( dL / g ) = a * Vsp / c \qquad ( equation 5 )$$

The samples to be analyzed are weighed out in concentrations of 10 mg/ml to 20 mg/ml. To avoid injecting possible gels and/or polymers which do not dissolve in TCB at 160° C., like PET and PA, the weighed out sample was packed into a stainless steel mesh MW 0,077/D 0.05 mmm.

After automated filling of the vial with 1,2,4-TCB containing 250 mg/l 2,6-tert-butyl-4-methylphenol (BHT) as antioxidant, the sample is dissolved at 160° C. until complete dissolution is achieved, usually for 60 min, with constant stirring of 400 rpm. To avoid sample degradation, the polymer solution is blanketed with the N2 atmosphere during dissolution.

A defined volume of the sample solution is injected into the column filled with inert support where the crystallization of the sample and separation of the soluble fraction from the crystalline part is taking place. This process is repeated two times. During the first injection the whole sample is measured at high temperature, determining the IV[dl/g] and the C2[wt. %] of the PP composition. During the second injection the soluble fraction (at low temperature) and the crystalline fraction (at high temperature) with the crystallization cycle are measured (wt.-% SF, wt.-% C2, IV).

### Melt Flow Rate

The melt flow rate (MFR) was determined according to ISO 1133 and is indicated in g/10 min. The MFR is an indication of the flowability, and hence the processability, of the polymer. The higher the melt flow rate, the lower the viscosity of the polymer. The MFR₂ of polypropylene was determined at a temperature of 230° C. and a load of 2.16 kg.

### Density:

The density was measured according to ISO 1183-187. Sample preparation was done by compression moulding in accordance with ISO 1872-2:2007.

The xylene soluble fraction at room temperature (XCS, wt.-%): The amount of the polymer soluble in xylene was determined at 25° C. according to ISO 16152; 5^{th} edition; 2005-07-01.

DSC analysis, melting temperature (Tₘ) and heat of fusion (H_{f}), crystallization temperature (T_{c}) and heat of crystallization (H_{c}): measured with a TA Instrument Q200 differential scanning calorimetry (DSC) on 5 to 7 mg samples. DSC was run according to ISO 11357/part 3/method C2 in a heat/cool/heat cycle with a scan rate of 10° C./min in the temperature range of −30 to +225° C. Crystallization temperature (T_{c}) and crystallization enthalpy (H_{c}) were determined from the cooling step, while melting temperature (Tₘ) and melting enthalpy (Hₘ) were determined from the second heating step.

### DDI

### ISO 7765-1:1988/Method A

This test method covers the determination of the energy that causes films to fail under specified conditions of impact of a free-falling dart from a specified height that would result in failure of 50% of the specimens tested (Staircase method A). A uniform missile mass increment is employed during the test and the missile weight is decreased or increased by the uniform increment after test of each specimen, depending upon the result (failure or no failure) observed for the specimen.

### Standard Conditions:

Conditioning time: >96 h
Test temperature: 23° C.
Dart head material: phenolic
Dart diameter: 38 mm
Drop height: 660 mm

### Results:

Impact failure mass [g]
Minimum thickness [mm]
Maximum thickness [mm]

Testing according to ISO7765-1:1988/Method A was carried out on films with a thickness as indicated and produced as described below under “Examples” and reported in gram (g). DDI per unit thickness (in g/micron) is calculated by dividing DDI (in gram) to the thickness of film (in micron).

### Haze

Haze was determined according to ASTM D1003-00 directly on the multilayer film produced in the experimental section.

### Sealing Range Experiments (SIT, Max Sealing Force and SET)

This method is used to determine the sealing window (sealing temperature range) of films. The procedure is similar to Hot-Tack test and is conducted in the same machine. In contrast to Hot-Tack, the sealing range determined corresponds to the strength of the seal after it had cooled down (a delay time of 30 s). The conditions used are as follows:
Sealing time (1 s)
Sealing pressure (0.4 N/mm²)
Delay time (30 s)
Clamp separation rate (42 mm/s)

$$Sealing range = ( Seal initiation temperature until seal end temperature )$$

The determined results provide a quantitatively useful indication of the sealing strength of the films and indicate the temperature range for optimal sealing.

The lower limit (Sealing Initiation Temperature—SIT) is the sealing temperature at which a sealing average force of 5 N is measured (i.e. the lowest temperature at which such force is measured). The upper limit (Sealing End Temperature—SET) is identified as the first sealing temperature where at least two specimens showed a burn-through failure mode. The maximum sealing force corresponds to the highest measured sealing force.

The temperature interval is set by default to 5° C., but can be reduced to 1° C. when the curve shows a sharp increase or decrease in the force values between two temperature steps. This is done in order to represent a better curve profile.

Deviating from ASTM F1921-12, the test parameters sealing pressure, cooling time and test speed are modified. The determination of the force/temperature curve is continued until thermal failure of the film. In addition to failure mode evaluations described in the standard, additional failure modes are used.

### Seal Strength

The heat-seal experiments were performed on at least 3 film specimens of 85 mm wide by 200 mm length cut in the machine direction. The 5 mm×150 mm Teflon coated steel heating bars were set to a temperature of 110° C. Two films were sealed by positioning, one on top of the other using a 0.5 s sealing time and 0.67 N/mm² pressure. The resulting sealed area was 85 mm×5 mm. The specimens were then conditioned for 7 days (±24 h) at 23° C. (±2° C.)/50% RH (±10%). 10 specimens of 15 mm width were cut and tested in tensile mode at 23° C. (±2° C.)/50% RH (±10%) on a Universal Testing Machine (Zwick Z005).

The clamping distance used was 100 mm, and a test speed of 200 mm/min. The yielding force and maximum force were measured for each test specimen.

### Basic Sealing:

Film width: 85 mm
Film length: >200 mm
Sealed seam width: 5 mm
Sealing temperature: 110° C.
Sealing pressure: 0.67 N/mm²
Sealing time: 0.5 s
Sealing jaws: Teflon coated

### Conditioning

Conditioning time: 7 days (±24 h) at 23° C. (2° C.)/50% RH (10%)

### Heat Seal Strength:

Test temperature: 23° C. (±2° C.)/50% RH (10%)
Specimen width: 15 mm
Gripping distance: 100 mm
Test speed: 200 mm/min
Test device: Universal Testing Machine

### Tensile Modulus

Tensile modulus in machine and transverse direction was determined according to ISO 527-3 at 23° C. on the multilayer films produced in the experimental section. Testing was performed at a cross-head speed of 1 mm/min.

### Steam Sterilization

Steam sterilization was performed in a Systec D series machine (Systec Inc., USA). The samples were heated up at a heating rate of 5° C./min starting from 23° C. After having been kept for 30 min at 130° C., they were removed immediately from the steam sterilizer and stored at room temperature before being further processed or tested.

### 2. Examples

### 2.1 Synthesis of Heterophasic Propylene-Ethylene Copolymers (RAHECO, HECO1 and HECO2

For the polymerization process of HECO2, a Ziegler-Natta type catalyst as used in for the inventive examples of WO2016/066446 A1 and prepolymerized with vinylcyclohexane to achieve nucleation with poly(vinylcycloxehane) was used.

Nucleation by prepolymerization with vinylcyclohexane is described in EP290256 B1 and EP2960279B1 in detail.

For the polymerizsation process of RAHECO and HECO 1, the same catalyst was used except that no pre-polymerization with vinylcyclohexane was undertaken (i.e. simply the catalyst used for the inventive examples of WO 2016/066446 A1 was used).

The catalyst systems defined above was used in combination with triethyl-aluminium (TEAL) as co-catalyst and dicyclopenta dienyl-dimethoxy silane (Donor D) as external donor.

The subsequent polymerizations have been effected under the following conditions.

TABLE 1
Polymerization conditions for the heterophasic
propylene-ethylene copolymers

| | | |
|---|---|---|
| RAHECO | HECO1 | HECO2 |

Prepolymerization

| | | | | |
|---|---|---|---|---|
| [Co]/[ED] | [mol/mol] | 9.5 | 10.0 | 8.0 |
| [Co]/[Ti] | [mol/mol] | 180 | 200 | 173 |
| Temperature | [° C.] | 30 | 30 | 30 |
| Residence time | [min] | 15 | 15 | 15 |

Loop reactor

| | | | | |
|---|---|---|---|---|
| Temperature | [° C.] | 80 | 80 | 80 |
| Split | [wt.-%] | 36 | 41 | 39 |
| H2/C3 | [mol/kmol] | 0.24 | 0.30 | 0.40 |
| C2/C3 | [mol/kmol] | 3.5 | 0.0 | 0.0 |
| MFR₂ | [g/10 min] | 0.70 | 0.85 | 2.40 |
| C2 | [wt.-%] | 2.5 | 0.0 | 0.0 |

1^{st} Gas phase reactor

| | | | | |
|---|---|---|---|---|
| Temperature | [° C.] | 80 | 80 | 80 |
| Split | [wt.-%] | 46 | 42 | 50 |
| H2/C3 | [mol/kmol] | 2.3 | 2.9 | 7.0 |
| C2/C3 | [mol/kmol] | 5.3 | 0.0 | 0.0 |
| MFR₂ | [g/10 min] | 0.70 | 0.85 | 2.4 |
| XCS | [wt.-%] | 8.0 | 1.7 | 1.8 |
| C2 | [wt.-%] | 4.0 | 0.0 | 0.0 |

2^{nd} Gas phase reactor

| | | | | |
|---|---|---|---|---|
| Temperature | [° C.] | 75 | 75 | 75 |
| Split | [wt.-%] | 18 | 17 | 11 |
| H2/C3 | [mol/kmol] | 80 | 60 | 116 |
| C2/C3 | [mol/kmol] | 290 | 480 | 210 |
| MFR₂ | [g/10 min] | 0.80 | 0.85 | 3.00 |
| C2 | [wt.-%] | 9.5 | 7.7 | 4.9 |

Final Properties (pellet)

| | | | | |
|---|---|---|---|---|
| MFR₂ | [g/10 min] | 0.80 | 0.85 | 3.00 |
| C2 | [wt.-%] | 9.5 | 7.7 | 4.9 |
| SF | [wt.-%] | 21.1 | 14.4 | 11.2 |
| C2(SF) | [wt.-%] | 30.2 | 37.5 | 29.1 |
| iV(SF) | [dL/g] | 2.89 | 2.83 | 2.02 |
| CF | [wt.-%] | 78.2 | 85.6 | 88.8 |
| C2(CF) | [wt.-%] | 4.9 | 3.4 | 2.2 |
| iV(CF) | [dL/g] | 3.08 | 3.02 | 2.66 |
| iV(SF)/iV(CF) | [—] | 0.94 | 0.94 | 0.76 |
| Tm | [° C.] | 141 | 165 | 168 |

The matrices of each of RAHECO, HECO1 and HECO2 are free from 2,1-regiodefects.

RAHECO was compounded in a co-rotating twin-screw extruder Coperion ZSK 47 at 220° C. with 0.19 wt.-% of an antioxidant blend (Irganox B215FF from BASF AG, Germany; this is a 1:2-mixture of Pentaerythrityl-tetrakis(3-(3′,5′-di-tert. butyl-4-hydroxyphenyl)-propionate, CAS-no. 6683-19-8, and Tris (2,4-di-t-butylphenyl) phosphite, CAS-no. 31570-04-4); 0.05 wt.-% of Ca-stearate (CAS-no. 1592-23-0, commercially available from Faci, Italy).

HECO1 was compounded in a co-rotating twin-screw extruder Coperion ZSK 47 at 220° C. with 0.15 wt.-% of pentaerythrityl-tetrakis(3-(3′,5′-di-tert. butyl-4-hydroxyphenyl)-propionate (available as Irganox 1010 from BASF AG, Germany; CAS-no. 6683-19-8); and 0.05 wt.-% of Ca-stearate (CAS-no. 1592-23-0, commercially available from Faci, Italy).

HECO2 was compounded in a co-rotating twin-screw extruder Coperion ZSK 47 at 220° C. with 0.05 wt.-% of pentaerythrityl-tetrakis(3-(3′,5′-di-tert. butyl-4-hydroxyphenyl)-propionate (available as Irganox 1010 from BASF AG, Germany; CAS-no. 6683-19-8); 0.10 wt.-% of tris (2,4-di-t-butylphenyl) phosphite (available as Irgafos 168 from BASF AG, Germany; CAS-no. 31570-04-4); 0.03 wt.-% of synthetic hydrotalcite (available as Hycite 713 from BASF AG, Germany; CAS-no. 11097-59-9); and 0.05 wt.-% of a nucleating agent (available as Hyperform HPN-20E from Milliken, USA; CAS-no (of main component) 491589-22-1).

### 2.2 Propylene-Ethylene Random Copolymers (R-PP1 and R-PP2)

The catalyst used in the polymerization process for the propylene-ethylene random copolymers R-PP1 and R-PP2 was prepared as follows:

The metallocene MC1 (rac-anti-dimethylsilandiyl(2-methyl-4-phenyl-5-methoxy-6-tert-butyl-indenyl)(2-methyl-4-(4-tert-butylphenyl)indenyl)zirconium dichloride) has been synthesized as described in WO 2013/007650.

The catalyst was prepared using metallocene MC1 and a catalyst system of MAO and trityl tetrakis(pentafluorophenyl)borate according to Catalyst 3 of WO 2015/11135 with the proviso that the surfactant is 2,3,3,3-tetrafluoro-2-(1,1,2,2,3,3,3-heptafluoropropoxy)-1-propanol.

TABLE 2
Polymerization conditions for the propylene-
ethylene random copolymers

| | |
|---|---|
| R-PP1 | R-PP2 |

Prepolymerization

| | | | |
|---|---|---|---|
| Temperature | ° C. | 17 | 20 |
| Residence time | min | 0.4 | 0.4 |

Loop reactor

| | | | |
|---|---|---|---|
| Temperature | ° C. | 68 | 65 |
| Feed H2/C3 ratio | [mol/kmol] | 0.1 | 0.1 |
| Feed C2/C3 ratio | [mol/kmol] | 15.2 | 32.1 |
| Split | [wt.-%] | 63 | 52 |
| MFR₂ | [g/10 min] | 4.48 | 2.67 |
| C2 content | [wt.-%] | 0.51 | 2.20 |

First GPR

| | | | |
|---|---|---|---|
| Temperature | [° C.] | 83 | 83 |
| H2/C3 ratio | [mol/kmol] | 0.7 | 1.2 |
| C2/C3 ratio | [mol/kmol] | 97.6 | 119.8 |
| Split | [wt.-%] | 37 | 48 |

Pellet

| | | | |
|---|---|---|---|
| C2 total | [wt.-%] | 1.1 | 2.5 |
| 2,1-regiodefects | [mol-%] | 0.6 | 0.5 |
| MFR₂ | [g/10 min] | 2.0 | 1.7 |
| Tm | [° C.] | 145 | 128 |
| XCS | [wt.-%] | 0.51 | 0.57 |

R-PP1 was compounded in a co-rotating twin-screw extruder Coperion ZSK 47 at 220° C. with 0.05 wt.-% of pentaerythrityl-tetrakis(3-(3′,5′-di-tert. butyl-4-hydroxyphenyl)-propionate (available as Irganox 1010 from BASF AG, Germany; CAS-no. 6683-19-8); 0.05 wt.-% of tris (2,4-di-t-butylphenyl) phosphite (available as Irgafos 168 from BASF AG, Germany; CAS-no. 31570-04-4); 0.03 wt.-% of synthetic hydrotalcite (available as Hycite 713 from BASF AG, Germany; CAS-no. 11097-59-9); and 0.08 wt.-% of a nucleating agent (available as ADK Stab NA-71 from Adeka Corporation, Germany; CAS-no (of main component) 85209-93-4).

R-PP2 was compounded in a co-rotating twin-screw extruder Coperion ZSK 47 at 220° C. with 0.20 wt.-% of erucamide (available as Crodamide ER beads from Croda International, UK; CAS-no. 112-84-5); 0.18 wt.-% of amorphous silica (available as Sylobloc 45B from Grace GmbH, Germany; CAS-no. 7631-86-9); 0.10 wt.-% of an antioxidant blend (available as Irganox B215FF from BASF AG, Germany; this is a 1:2-mixture of Pentaerythrityl-tetrakis(3-(3′,5′-di-tert. butyl-4-hydroxyphenyl)-propionate, CAS-no. 6683-19-8, and Tris (2,4-di-t-butylphenyl) phosphite, CAS-no. 31570-04-4); and 0.04 wt.-% of Ca-stearate (available from Faci, Italy; CAS-no. 1592-23-0) and 2.0 wt.-% of the propylene homopolymer described in EP 3 184 587, Table 1, IE2.

Furthermore, R-PP2 was visbroken using 2,5-bis(tert-butylperoxy)-2,5-dimethylhexane to achieve an MFR₂ of 11.0 g/10 min. The XCS, Tm, C2(total) and content of 2,1-regiodefects were not altered during the visbreaking process.

### 2.3 Compounding of Inventive and Comparative Multilayer Films

The compositions for each layer were prepared based on the recipes indicated in Table 3 by compounding in a co-rotating twin-screw extruder Coperion ZSK 40 at 220° C.

3-layer films are produced on Collin lab scale blown film line, film thickness 60 μm, BUR 1:2.5, melt temperature 210° C. The film thickness distribution is skin 25%, core 50%, and sealing layer 25%.

The properties of the inventive and comparative compositions are given in Table 4.

TABLE 3
Recipes for inventive and comparative examples

| | | | CE1 | IE1 | IE2 | IE3 |
|---|---|---|---|---|---|---|
| Skin | RAHECO | [wt.-%] | 30 | 30 | 30 | 30 |
| layer | HECO1 | [wt.-%] | 70 | 70 | 70 | 70 |
| Core | RAHECO | [wt.-%] | 30 | 30 | 30 | 30 |
| layer | HECO1 | [wt.-%] | 70 | 70 | 70 | 70 |
| Sealing | RAHECO | [wt.-%] | — | 40 | 40 | 40 |
| layer | R-PP1 | [wt.-%] | — | 16 | 30 | 44 |
| | R-PP2 | [wt.-%] | — | 44 | 30 | 16 |
| | HECO2 | [wt.-%] | 100 | — | — | — |

TABLE 4
Properties of the inventive and comparative multilayer films

| | | CE1 | IE1 | IE2 | IE3 |
|---|---|---|---|---|---|
| Tensile Modulus (MD) | [MPa] | 1140 | 860 | 970 | 860 |
| Tensile Modulus (TD) | [MPa] | 1100 | 850 | 1010 | 950 |
| DDI | [g] | 173 | 386 | 138 | 226 |
| Haze | [%] | 27.6 | 32.8 | 28.5 | 31.2 |
| SIT | [° C.] | 145 | 122 | 125 | 125 |
| Seal strength (b.s.) | [N/15 mm] | 6.0 | 22.6 | 25.6 | 25.5 |
| Seal strength (a.s.) | [N/15 mm] | 5.4 | 27.1 | 30.3 | 29.4 |
| Seal strength (a.s.)/ | [%] | 90 | 120 | 118 | 115 |
| Seal strength (b.s.) | | | | | |

As can be seen from Table 4, the inventive multilayer films have significantly reduced SIT values, as well as drastically improved seal strength, both before and after sterilization, whilst maintaining acceptable mechanical and optical properties. Furthermore, the seal strength after sterilization is in all cases higher than before sterilization, in contrast to the comparative example, which experiences a reduction in seal strength.

1: A multilayer film (F), comprising, in the given order, the following layers:
(A) a skin layer, comprising at least 90 wt. %, based on the total weight of the skin layer, of a polypropylene or mixture of polypropylenes;
(B) a core layer, comprising at least 90 wt. %, based on the total weight of the core layer, of a polypropylene or mixture of polypropylenes; and
(C) a sealing layer, comprising at least 90 wt. %, based on the total weight of the sealing layer, of a polypropylene composition (PC) comprising the following components:
i) 20 to 70 wt. %, based on the total weight of the polypropylene composition (PC), of a random-heterophasic propylene-ethylene copolymer (RAHECO), having a melt flow rate (MFR₂), determined according to ISO 1133 at 230° C. and 2.16 kg, in the range from 0.1 to 10.0 g/10 min, comprising:
a) a crystalline matrix (M) being a propylene-ethylene random copolymer; and
b) an amorphous propylene-ethylene elastomer (E);
ii) 10 to 50 wt. %, based on the total weight of the polypropylene composition (PC), of a first propylene-ethylene random copolymer (R-PP1) having a melt flow rate (MFR₂), determined according to ISO 1133 at 230° C. and 2.16 kg, in the range from 1.0 to 6.0 g/10 min; and
iii) 10 to 50 wt. %, based on the total weight of the polypropylene composition (PC), of a second propylene-ethylene random copolymer (R-PP2) having a melt flow rate (MFR₂), determined according to ISO 1133 at 230° C. and 2.16 kg, in the range from 7.0 to 20 g/10 min,
wherein the combined amounts of the random-heterophasic propylene-ethylene copolymer (RAHECO), the first propylene-ethylene random copolymer (R-PP1) and the second propylene-ethylene random copolymer (R-PP2) are at least 90 wt. %, relative to the total weight of the polypropylene composition (PC).

2: The multilayer film (F) according to claim 1, wherein the random-heterophasic propylene-ethylene copolymer (RAHECO) has one or more of the following properties:
a) a soluble fraction (SF) content in the range from 10 to 45 wt. % and a crystalline fraction (CF) content in the range from 55 to 90 wt. %, both determined by CRYSTEX QC analysis;
b) a melting temperature (Tm), determined by differential scanning calorimetry (DSC), in the range from 130 to 155° C.; and
c) the crystalline matrix (M) being free from 2,1-regiodefects, as determined by quantitative ¹³C-NMR spectroscopy.

3: The multilayer film (F) according to claim 1, wherein the random-heterophasic propylene-ethylene copolymer (RAHECO) has one or more of the following properties:
a) an ethylene content (C2(total)), determined by CRYSTEX QC analysis, in the range from 3.0 to 15.0 wt. %;
b) an ethylene content of the soluble fraction (C2(SF)), determined by CRYSTEX QC analysis, in the range from 17.0 to 60.0 wt. %; and
c) an ethylene content of the crystalline fraction (C2(CF)), determined by CRYSTEX QC analysis, in the range from 1.0 to 8.0 wt. %.

4: The multilayer film (F) according to claim 1, wherein the random-heterophasic propylene-ethylene copolymer (RAHECO) has one or more of the following properties:
a) an intrinsic viscosity of the soluble fraction (iV(SF)), determined by CRYSTEX QC analysis, in the range from 1.20 to 4.50 dL/g;
b) an intrinsic viscosity of the crystalline fraction (iV(CF)), determined by CRYSTEX QC analysis, in the range from 1.20 to 4.50 dL/g; and
c) an intrinsic viscosity ratio (iV(SF)/iV(CF)), determined by CRYSTEX QC analysis, in the range from 0.50 to 2.00.

5: The multilayer film (F) according to claim 1, wherein the first propylene-ethylene random copolymer (R-PP1) has one or more of the following properties:
a) an ethylene content (C2), determined by quantitative ¹³C-NMR spectroscopy, in the range from 1.0 to 5.5 wt. %;
b) a xylene cold soluble (XCS) content, determined according to ISO 16152 analysis, in the range from 0.2 to 5.0 wt. %;
c) a melting temperature (Tm), determined by differential scanning calorimetry (DSC), in the range from 130 to 155° C.;
d) a crystallization temperature (Tc), determined by differential scanning calorimetry (DSC), in the range from 110 to 125° C.; and
e) a content of 2,1-regiodefects, as determined by quantitative ¹³C-NMR spectroscopy, in the range from 0.05 to 1.40 mol %.

6: The multilayer film (F) according to claim 1, wherein the second propylene-ethylene random copolymer (R-PP2) has one or more of the following properties:
a) an ethylene content (C2), determined by quantitative ¹³C-NMR spectroscopy, in the range from 1.0 to 5.5 wt. %;
b) a xylene cold soluble (XCS) content, determined according to ISO 16152 analysis, in the range from 0.2 to 5.0 wt. %;
c) a melting temperature (Tm), determined by differential scanning calorimetry (DSC), in the range from 125 to 145° C.;
d) a crystallization temperature (Tc), determined by differential scanning calorimetry (DSC), in the range from 100 to 120° C.; and
e) a content of 2,1-regiodefects, as determined by ¹³C-NMR spectroscopy, in the range from 0.05 to 1.40 mol %.

7: The multilayer film (F) according to claim 1, wherein:
a) the skin layer has a thickness in the range from 10 to 40% of the total thickness of the multilayer film (F);
b) the core layer has a thickness in the range from 30 to 70% of the total thickness of the multilayer film (F); and
c) the sealing layer has a thickness in the range from 10 to 40% of the total thickness of the multilayer film (F).

8: The multilayer film (F) according to claim 1, wherein at least one of the skin layer and the core layer comprise at least 90 wt. % of a polypropylene composition (PC′) comprising the following components:
i) from 15 to 45 wt. %, based on the total weight of the polypropylene composition (PC′), of a random-heterophasic propylene-ethylene copolymer (RAHECO′) having a melting temperature (Tm), determined by differential scanning calorimetry (DSC), in the range from 130 to 155° C.,
wherein the random-heterophasic propylene-ethylene copolymer (RAHECO′) comprises:
a1) a crystalline matrix (M) being a propylene-ethylene random copolymer; and
b1) an amorphous propylene-ethylene elastomer (E), and
ii) from 55 to 85 wt. %, based on the total weight of the polypropylene composition (PC′), of a heterophasic propylene-ethylene copolymer (HECO) having a melting temperature (Tm), determined by differential scanning calorimetry (DSC), in the range from 150 to 170° C.,
wherein the heterophasic propylene-ethylene copolymer (HECO) comprises:
a2) a crystalline matrix (M) being a propylene homopolymer; and
b2) an amorphous propylene-ethylene elastomer (E),
wherein the combined amounts of the random-heterophasic propylene-ethylene copolymer (RAHECO′) and the heterophasic propylene-ethylene copolymer (HECO) are at least 90 wt. %, relative to the total weight of the polypropylene composition (PC′).

9: The multilayer film (F) according to claim 8, wherein the random-heterophasic propylene-ethylene copolymer (RAHECO′) has one or more of the following properties:
a) a melt flow rate (MFR₂), determined according to ISO 1133 at 230° C. and 2.16 kg, in the range from 0.1 to 10.0 g/10 min;
b) a soluble fraction (SF) content in the range from 10 to 45 wt. % and a crystalline fraction (CF) content in the range from 55 to 90 wt. %, both determined by CRYSTEX QC analysis;
c) an ethylene content (C2(total)), determined by CRYSTEX QC analysis, in the range from 3.0 to 15.0 wt. %;
d) an ethylene content of the soluble fraction (C2(SF)), determined by CRYSTEX QC analysis, in the range from 17.0 to 60.0 wt. %;
e) an ethylene content of the crystalline fraction (C2(CF)), determined by CRYSTEX QC analysis, in the range from 1.0 to 8.0 wt. %;
f) an intrinsic viscosity of the soluble fraction (iV(SF)), determined by CRYSTEX QC analysis, in the range from 1.20 to 4.50 dL/g;
g) an intrinsic viscosity of the crystalline fraction (iV(CF)), determined by CRYSTEX QC analysis, in the range from 1.20 to 4.50 dL/g; and
h) an intrinsic viscosity ratio (iV(SF)/iV(CF)), determined by CRYSTEX QC analysis, in the range from 0.50 to 2.00.

10: The multilayer film (F) according to claim 8, wherein the heterophasic propylene-ethylene copolymer (HECO) has one or more of the following properties:
a) a melt flow rate (MFR₂), determined according to ISO 1133 at 230° C. and 2.16 kg, in the range from 0.1 to 6.0 g/10 min;
b) a soluble fraction (SF) content in the range from 5 to 30 wt. % and a crystalline fraction (CF) content in the range from 70 to 95 wt. %, both determined by CRYSTEX QC analysis;
c) an ethylene content (C2(total)), determined by CRYSTEX QC analysis, in the range from 3.0 to 15.0 wt. %;
d) an ethylene content of the soluble fraction (C2(SF)), determined by CRYSTEX QC analysis, in the range from 17.0 to 60.0 wt. %;
e) an ethylene content of the crystalline fraction (C2(CF)), determined by CRYSTEX QC analysis, in the range from 1.0 to 8.0 wt. %;
f) an intrinsic viscosity of the soluble fraction (iV(SF)), determined by CRYSTEX QC analysis, in the range from 1.20 to 4.50 dL/g; and
g) an intrinsic viscosity of the crystalline fraction (iV(CF)), determined by CRYSTEX QC analysis, in the range from 1.20 to 4.50 dL/g.

11: The multilayer film (F) according to claim 8, wherein the random-heterophasic propylene-ethylene copolymer (RAHECO′) is the same as the random-heterophasic propylene-ethylene copolymer (RAHECO).

12: The multilayer film (F) according to claim 1, having a thickness in the range from 20 to 150 μm.

13: The multilayer film (F) according to claim 1, having one or more of the following properties:
a) a tensile modulus in the machine direction (TM-MD), measured according to ISO 527-3, in the range from 700 to 1500 MPa;
b) a tensile modulus in the transverse direction (TM-TD), measured according to ISO 527-3, in the range from 700 to 1500 MPa; and
c) a dart drop impact strength (DDI), measured according to ISO 7765-1, in the range from 100 to 600 g.

14: The multilayer film (F) according to claim 1, having a haze value, determined according to ASTM D1003, in the range from 10 to 40%.

15: The multilayer film (F) according to claim 1, having one or more of the following properties:
a) a sealing initiation temperature (SIT), in the range from 115 to 130° C.;
b) a seal strength before sterilization (b.s.), in the range from 15 to 40 N/mm; and
c) a seal strength after sterilization (a.s.), in the range from 20 to 45 N/mm.
